(19) United States
(12) Patent Application Publication
(10) Pub. No.: US 2025/0056376 A1
(43) Pub. Date: Feb. 13, 2025

(54) SYSTEMS AND METHODS FOR INTEGRATED ACCESS AND BACKHAUL ENCAPSULATION IN HYBRID BACKHAUL NETWORKS

(71) Applicant: Telefonaktiebolaget LM Ericsson (PUBL), Stockholm (SE)

(72) Inventors: Boris DORTSCHY, Vendelsö (SE); Paolo DEBENEDETTI, Genova (IT); Eduardo LINS DE MEDEIROS, Sundbyberg (SE); Raoul FIORONE, Genova (IT); Ajmal MUHAMMAD, Sollentuna (SE)

(21) Appl. No.: 18/718,248

(22) PCT Filed: Dec. 17, 2021
(86) PCT No.: PCT/EP2021/086488

§ 371 Date: Jun. 10, 2024

(51) Int. Cl. H04W 40/34; H04W 40/22

(52) U.S. Cl. CPC H04W 40/34; H04W 40/22

(57) ABSTRACT

A method (1000) by a first network node (110) implementing Integrated Access and Backhaul, IAB, protocols includes communicating (1002), with a second network node (110), IAB data over a non-radio transport network via a non-radio transport protocol stack.

### TECHNICAL FIELD

The present disclosure relates, in general, to wireless communications and, more particularly, systems and methods for Integrated Access and Backhaul (IAB) encapsulation in hybrid backhaul networks.

### BACKGROUND

3^{rd} Generation Partnership Project (3GPP) has provided standards for Integrated Access and Backhaul (IAB) in New Radio (NR) in Rel-16, for example, including in 3GPP RP-200084, Revised WID: Integrated Access and Backhaul for NR, Qualcomm, 3GPP TSG RAN meeting #87e, March 2020.

The usage of short-range millimeter wave (mmW) spectrum in NR allows for densified deployment but also creates a need for an extended backhaul network deployment. However, optical fiber to every base station will be too costly and sometimes not even possible (e.g. in historical or protected areas). The main principle of IAB is the use of wireless links for the backhaul (i.e., instead of fiber) to enable flexible and very dense deployment of cells without the need for densifying the transport network. Use case scenarios for IAB can include coverage extension, deployment of massive number of small cells and Fixed Wireless Access (FWA) (e.g., to residential/office buildings). The larger bandwidth available for NR in mmW spectrum provides opportunity for self-backhauling, not limiting spectrum to be used for access links only. On top of that, the inherent multi-beam and Multiple-Input Multiple-Output (MIMO) support in NR reduces cross-link interference between backhaul and access links allowing higher densification (in some frequency bands).

During the study item phase of the IAB work (for example, as included in technical report 3GPP TR 38.874), it has been agreed to adopt a solution that leverages the Central Unit (CU)/Distributed Unit (DU) split architecture of NR, where the IAB node will be hosting a DU part that is connected to a central unit in an IAB donor node. See, 3GPP, TR 38.874 V16.0.0—Study on Integrated Access and Backhaul, http://www.3gpp.org/ftp//Specs/archive/38_series/38.874/38874-g00.zip. The IAB nodes also have a Mobile Termination (MT) function that is used to communicate with their parent nodes.

The specifications for IAB strive to reuse existing functions and interfaces defined in NR. In particular, Mobile-Termination (MT), gNodeB-Distributed Unit (gNB-DU), gNodeB-Central Unit (gNB-CU), User Plane Function (UPF), Applications Management Function (AMF), and Sessions Management Function (SMF), as well as the corresponding interfaces NR Uu (between MT and gNodeB (gNB)), F1, NG, X2, and N4, are used as baseline for the IAB architectures. Modifications or enhancements to these functions and interfaces for the support of IAB will be explained in the context of the architecture discussion. Additional functionality such as multi-hop forwarding is included in the architecture discussion as it is necessary for the understanding of IAB operation and since certain aspects may require standardization.

As noted above, the MT function has been defined as a component of the IAB node. MT is referred to as a function residing on an IAB-node that terminates the radio interface layers of the backhaul Uu interface toward the IAB-donor or other IAB-nodes.

FIG. 1 illustrates a high-level architectural view of an IAB network in a reference diagram for IAB in standalone mode, which contains one IAB-donor and multiple IAB-nodes. The IAB-donor is treated as a single logical node that comprises a set of functions such as gNB-DU, gNB-CU-CP, gNB-CU-UP and potentially other functions. In a deployment, the IAB-donor can be split according to these functions, which can all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks.

FIG. 2 illustrates the baseline user plane (UP) stack for IAB, and FIGS. 3A-3C illustrate the baseline control plane (CP) protocol stack for IAB, as disclosed in 3GPP TR 38.874 Release 16 (Rel-16). As shown in FIGS. 2 and 3A-3C, the chosen protocol stacks reuse the current CU-DU split specification in Release 15 (Rel-15), where the full user plane F1-U (General packet radio service Tunneling Protocol-User Tunnel (GTP-U)/User Datagram Protocol (UDP)/Internet Protocol (IP)) is terminated at the IAB node (like a normal DU) and the full control plane F1-C (F1-Application Protocol (F1-AP)/Stream Control Transmission Protocol (SCTP)/IP) is also terminated at the IAB node (like a normal DU). In the above cases, Network Domain Security (NDS) has been employed to protect both UP and CP traffic (IP security (IPsec) in the case of UP, and Datagram Transport Layer Security (DTLS) in the case of CP). IPsec could also be used for the CP protection instead of DTLS (in this case no DTLS layer would be used).

### Backhaul Adaptation Protocol

A protocol layer called Backhaul Adaptation Protocol (BAP) has been introduced in the IAB nodes and the IAB-donor, which is used for routing of packets to the appropriate downstream/upstream node and for mapping the UE bearer data to the proper backhaul Radio Link Control (RLC) channel (and also between ingress and egress backhaul RLC channels in intermediate IAB nodes) to satisfy the end-to-end Quality of Service (QoS) requirements of bearers.

The user equipment (UE) establishes RLC channels to the DU on the UE's access IAB-node in compliance with TS 38.300. See, 3GPP, TS 38.300 V16.5.0—NR and NG-RAN Overall Description: Stage 2, http://www.3gpp.org/ftp//Specs/archive/-38_series/38.300/38300-g50.zip. Each of these RLC-channels is extended via F1-U between the UE's access DU and the IAB-donor. The information embedded in F1-U is carried over backhaul RLC-channels across the backhaul links. Transport of F1-U over the wireless backhaul will be performed by the Backhaul Adaptation Protocol (BAP). Since BAP is a newly defined layer for IAB networks, 3GPP has made the following agreements related to the BAP layer functionality:
Radio Access Network-2 (RAN2) confirms that routing and bearer mapping (e.g., mapping of Backhaul (BH) RLC channels) are BAP layer functions.
RAN2 assumes that the transmission (TX) part of the BAP layer performs routing and “bearer mapping”, and the reception (RX) part of the BAP layer performs “bearer de-mapping”.
RAN2 assumes that Service Data Units (SDUs) are forwarded from the RX part of the BAP layer to the TX part of the BAP layer (for the next hop) for packets that are relayed by the IAB node.
The BAP has a DU part configured by F1-AP and a Mobile Termination (MT) part configured by Radio Resource Control (RRC).
BAP specification should focus on describing the interaction on Uu (mindset).
A BAP DU part and MT part each has one transmitter and one receiver.

Furthermore, for the BAP routing, 3GPP has made the following agreements:
The BAP routing identifier (BAP routing ID) (carried in the BAP header) consists of BAP address and BAP path identifier (BAP path ID). Encoding of the path identifier (path ID) in the header is for future study (FFS).
Each BAP address defines a unique destination (unique for IAB network of one donor-IAB, either an IAB access node, or the IAB donor).
Each BAP address can have one or multiple entries in the routing table to enable local route selection. Multiple entries are for load balancing, re-routing at Radio Link Failure (RLF). For load balancing still FFS what is decided locally and/or decided by the Donor.
Each BAP routing ID has only one entry in the routing table.
The routing table can hold other information such as, for example, priority level for entries with same BAP address to support local selection. Configuration of this information is optional.
Load balancing by routing by donor-IAB CU shall be possible.
Local selection of path/route is done at link failure, other cases FFS.
The BAP address of the IAB node is used to differentiate traffic to be delivered to upper layers from traffic to be delivered to egress RLC layer (FFS for the Donor node).
For routing and bearer mapping of a packet retrieved from RLC layer, the IAB-node needs to be configurable with the following mappings:
   BAP routing ID in BAP header→Egress link (routing table)
   Ingress RLC channel→Egress RLC channel (bearer mapping).
For the selection/addition of a BAP routing ID as well as routing and bearer mapping for a packet retrieved from upper layers, the IAB-node and IAB donor needs to be configurable with the following mappings:
   Upper layer information→BAP Routing ID to be added in BAP header
   BAP routing ID in BAP header→Egress link
   Upper layer information→Egress RLC channel

IAB technology will benefit from spectrum abundance in the mmW bands. This allows backhaul links to occupy a certain part of radio resources while other parts are used for access. FIG. 4 illustrates an example scenario including IAB links. However, there currently exist certain challenge(s). For example, an IAB node can multiplex access and backhaul links in time, frequency, and/or space (e.g., beam-based operation). The operation of access and backhaul may be on the same or different frequencies (also termed ‘in-band’ and ‘out-of-band’ relaying). While efficient support of out-of-band relays is important for some NR deployment scenarios, it is critically important to support in-band operation which implies tighter interworking with the access links operating on the same frequency to accommodate duplex constraints and avoid/mitigate interference. Additionally, due to the short range of mmW access, extension of wireless backhauling to multiple hops is an essential feature.

Furthermore, operating NR systems in mmW spectrum presents some unique challenges including experiencing severe short-term blocking or long-term blocking due to fixed obstacles with no non-line-of-sight (NLOS) channel option.

One solution to deployment issues is to break the IAB tree in question and “fiberize” one of the nodes making this node a new donor node. In this scenario, the IAB node is connected via fiber to the core network via fiber backhaul. This in effect transforms one IAB tree into two trees, which can either be disjointed or not, depending how the downstream IAB nodes are configured, and a totally different entity that needs to be managed. Note that the fiber access must be connected to the core network somehow. It is not enough to have transceivers and fiber. There must also be logical connection(s) (such as F1, E1 interfaces) and capacity available at the core network nodes, i.e., Donor CUs.

Current architectures for DU and MT in IAB-nodes only consider NR as a physical layer (PHY) technology. This limits the available topologies to cases where all links in an IAB tree are limited by NR restrictions. The main NR restriction is the IAB-half-duplex limitation in scheduling. Specifically, according to 3GPP TR 38.874, the IAB-node cannot transmit and receive simultaneously on access and backhaul links. Additionally, NR systems in mm wavelength spectrum require the IAB nodes to be deployed in line-of-sight (LOS) fashion, which might lead to redundancy (i.e., extra IAB nodes) to cover corners cases. FIG. 5 illustrates such a case where the IAB4 is deployed only for providing/creating line of sight between the nodes IAB3 and IAB5. FIG. 6 illustrates an example of a transport connection to extend IAB service. FIG. 7 illustrates an example of intermediate transport span between IAB connections.

In addition, the use of radio makes the IAB network vulnerable to blockage such as, for example, due to moving object such as vehicles, due to seasonal changes (foliage), and/or due to infrastructure changes (new buildings). This problem can be solved by adding topologically redundant backhaul links and routes, enabling the IAB nodes to employ secondary/backup links or/and routes for data transmission in case the primary link or/and route is down. However, this approach does not guarantee lossless recovery from link failure/blockage and some data might be lost before recovering through the secondary/backup link or/and route.

Therefore, a solution is needed that does not require to connect an intermediate IAB relay node via fiber to the core network and does not have the vulnerability, sensitivity, and limitations of a wireless connection under, for example, NLOS operation.

### SUMMARY

To address the foregoing problems with existing solutions, disclosed is systems and methods that can selectively use a protocol stack so that data between a parent and an IAB node can be transferred over a physical layer that does not include a radio specific layer. Such systems may be specially applicable to highly densified urban RAN networks where the backhaul traffic can be provided by fiber infrastructure as well as IAB.

According to certain embodiments, a method by a first network node implementing IAB protocols includes communicating, with a second network node, IAB data over a non-radio transport network via a non-radio transport protocol stack.

According to certain embodiments, a first network node implementing IAB protocols is adapted to communicate, with a second network node, IAB data over a non-radio transport network via a non-radio transport protocol stack.

Certain embodiments of the present disclosure may provide one or more technical advantages. For example, certain embodiments may provide a technical advantage since the operator is to have a common mechanism and protocol for managing both traditional backhaul services and IAB services under the control of the 5G RAN network. Additionally, certain embodiments make it possible to implement hybrid backhaul coverage areas thanks to the combination of wireless and fiber connectivity. Some embodiments may provide one or more of the following advantages, for example:
Saving wireless spectrum wherever alternative transport links are available by tunneling IAB traffic over the, e.g., fiber (other transport standards and physical media are not excluded, e.g., microwave, copper),
Automatically finding alternative routes through the wireless IAB network wherever the fiber is not available, and/or
Coordinating transport and IAB connections from a single standpoint.

As another example, certain embodiments may provide a technical advantage since the RAN network can exploit both IAB and dedicated fiber backhaul. Thus, certain embodiments may provide one or more of the following further advantages:
Enabling the extension of IAB application space to more dense scenarios which today would require a full fiber (or dedicated wireless) backhaul,
Taking advantage of IAB utilizing part of the large spectrum available at mm wavelength frequencies for wireless backhauling, thus reducing the deployment cost of 5G networks, while providing a comparable performance to fiber deployment and indeed complementing it to create a hybrid solution to address IAB's intrinsic limitations,
Exploiting IAB standardized characteristics to build a hybrid backhaul solution seamlessly re-using the Backhaul Adaptation Protocol for, e.g., wireline transport purposes,
Using wired backhaul connections alongside IAB virtually (i.e., from IAB node perspective) to maintain the hop-by-hop characteristics of IAB networks,
Addressing and overcoming the bandwidth limits of a pure IAB solution, which is particularly applicable to the first IAB hop(s), i.e., that/those closer to the IAB donor, and/or
Addressing the use case of partial fiber availability and, thus, using the IAB solution in part of the network without being forced to deploy additional fiber strands or to build dedicated wireless links.

As still another example, certain embodiments may provide a technical advantage by preventing changes to the “logical” view of the IAB chain by providing enabling one or more of the following:
Keeping the management protocols for the IAB nodes intact (the change is transparent),
Enabling multiple PHYs (NR+others) to allow, for example, full duplex operation between nodes and, thus, partially reduce latency,
Bonding of traffic over NR and non-NR based links,
Protection switching (redundancy) between PHYs,
Increasing the availability of connectivity between two IAB nodes since connectivity is possible over independent and different PHYs,
Enabling flexibility for distribution of sync, and/or
Requiring no specification work/standard change.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a high-level architectural view of an IAB network in a reference diagram for IAB in standalone mode, which contains one IAB-donor and multiple IAB-nodes;

FIG. 2 illustrates the baseline UP stack for IAB;

FIGS. 3A-3C illustrates the baseline CP protocol stack for IAB;

FIG. 4 illustrates an example scenario including IAB links;

FIG. 5 illustrates a case where the IAB4 is deployed only for providing/creating line of sight between the nodes IAB3 and IAB5;

FIG. 6 illustrates an example of a transport connection to extend IAB service;

FIG. 7 illustrates an example of intermediate transport span between IAB connections;

FIG. 8 illustrates an example IAB network with nodes having multiple PHYs at the IAB-DU and/or IAB-MT, according to certain embodiments;

FIG. 9 illustrates an example IAB network with nodes IAB1 and IAB2 having a wire MAC in DU and MT, respectively, according to certain embodiments;

FIG. 10 illustrates an example of an IAB network using wired PHY for multi-connectivity purposes, according to certain embodiments;

FIG. 11 illustrates an example IAB network with direct wired connection between MT and DU functions belonging to different IAB nodes, according to certain embodiments;

FIG. 12 illustrates an example of an IAB network with the IAB-1 and IAB-donor having ethernet PHY for transporting F1 user plane traffic, according to certain embodiments;

FIG. 13 illustrates an example of an IAB network with the IAB-1 and IAB-donor having an no RLC layer and where the IP layer is optional in IAB-1 for transporting F1 control plane traffic, according to certain embodiments;

FIG. 14 illustrates an example embodiment for performing encapsulation and using dedicated bits to discriminate BAP packets over Radio from BAP packets over Ethernet, according to certain embodiments;

FIG. 15 illustrates BAP PDU encapsulation over Ethernet, according to certain embodiments;

FIG. 16 illustrates a BAP Control PDU format for flow control feedback per BAP routing ID, according to certain embodiments;

FIG. 17 illustrates an example communication system, according to certain embodiments;

FIG. 18 illustrates a UE, according to certain embodiments;

FIG. 19 illustrates a network node, according to certain embodiments;

FIG. 20 illustrates a block diagram of a host, according to certain embodiments;

FIG. 21 illustrates a virtualization environment in which functions implemented by some embodiments may be virtualized, according to certain embodiments;

FIG. 22 illustrates a host communicating via a network node with a UE over a partially wireless connection, according to certain embodiments; and

FIG. 23 illustrates a method by a first network node implementing IAB protocols, according to certain embodiments.

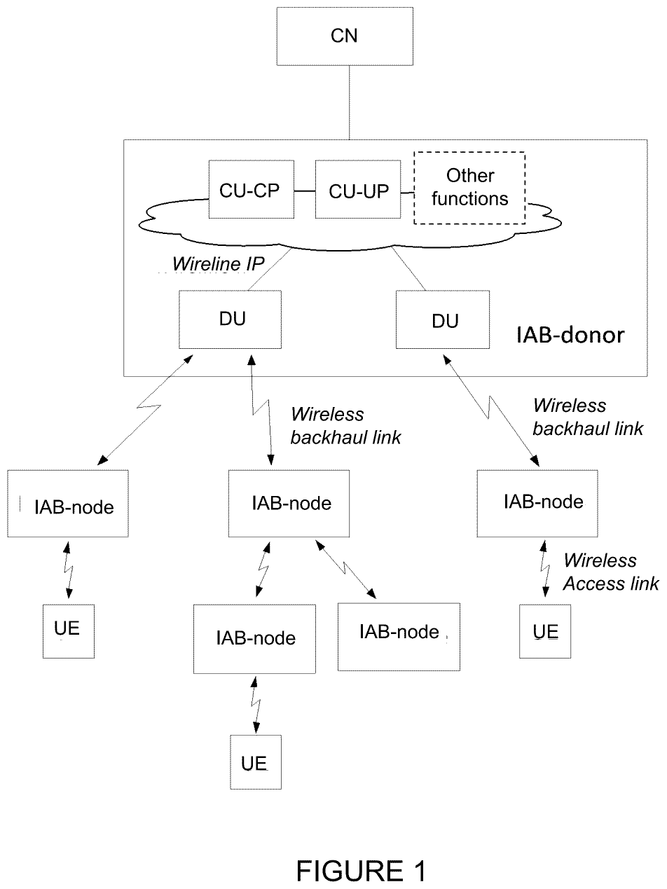

### DETAILED DESCRIPTION

Some of the embodiments contemplated herein will now be described more fully with reference to the accompanying drawings. Embodiments are provided by way of example to convey the scope of the subject matter to those skilled in the art.

Certain embodiments are disclosed herein for using an additional protocol stack in an IAB node architecture in such a way that data between a parent and an IAB node can be transferred using a protocol stack that does not include a radio specific layer (e.g. not using a PHY that specific to NR). According to certain embodiments, candidate PHYs are optical fiber transmission based. The systems and methods may be applicable, for example, to highly densified urban RAN networks where the backhaul traffic can be provided by fiber infrastructure as well as IAB.

According to certain embodiments, systems and methods are proposed for encapsulating and switching IAB traffic over an Ethernet transport infrastructure. Certain alternative embodiments may also include the usage of microwave links such as, for example, in case of a point-to-point (P2P) connection between IAB nodes. Accordingly, the IAB Donor may send the traffic to the IAB nodes passing over multiple hops based either on fixed wireline Ethernet connections or NR interfaces. The decision of whether to send the traffic on fixed wireline Ethernet connections or NR interfaces may be based on, for example, the network size, traffic patterns, and fiber availability. As such, certain embodiments may make the best use of NR spectrum based on these or other characteristics.

Certain embodiments described herein define two typologies of IAB connections:
“IAB-over-NR” as previously defined by 3GPP standards
IAB-over-Ethernet as introduced by certain embodiments described herein
   The switching of traffic among the nodes implementing this method is under IAB control using a hop-by-hop policy and standard switching as part of their relevant IP stack.

Since IAB nodes can use the same IP assignment methods as for fiber-connected radio nodes, certain features and embodiments described herein can be to facilitate an easy upgrade to fiber transport when needed and also to build hybrid backhaul networks, taking advantage of the benefits of IAB as much as possible and overcoming its limitations with fiber backhaul links or sub-networks.

Accordingly, certain embodiments are disclosed where an IAB node is augmented by adding wired MAC/PHY interfaces. These additions increase the flexibility of deployment and upgrades, while being transparent to the IAB signaling and not requiring change of specification.

For example, according to certain embodiments, a method implemented by a RAN node, in a multitude of interconnected RAN nodes, is provided to generate or receive IAB traffic and encapsulate it over a non-IAB transport link. As used herein, the non-IAB transport link may include any transport link that is not a radio transport link. For example, in certain embodiments, the non-IAB transport link may include a wireline such as, for example, fiber link. In other embodiments, the non-IAB transport link may include a wireless link such as, for example, or a microwave link. However, it is recognized that other transmission technologies may also be applicable and the non-IAB transport link may include any suitable link. References to an IAB link, IAB transport link or IAB-over-NR refer to connecting IAB nodes using a radio link, e.g. a cellular radio connection such as based on NR. The non-IAB transport link refers to a link configured to transport IAB data, but using a wired connection (e.g. an optical fiber and/or ethernet) or non-radio wireless link (e.g. microwave), instead of a radio link. Aspects of the disclosure specify transmitting and receiving IAB data over a non-IAB transport link, i.e. not by radio. The transmitting and receiving of IAB data uses one or more layers of a protocol stack which are adapted for the non-IAB transport link. As such, the protocol stack provides for efficient transport of IAB data without using radio.

In a particular embodiment, a RAN node receives IAB traffic encapsulated over an Ethernet interface and processes it according to 3GPP specifications. In a further particular embodiment, the IAB donor may encapsulate IAB traffic over an Ethernet transport link instead of the NR interface. As used herein, the IAB Donor includes a CU and has a wireline backhaul.

In a particular embodiment, the RAN node receives IAB traffic encapsulated over an Ethernet interface and forwards it to another Ethernet interface, transforming an IAB-node into a switching device.

In still another particular embodiment, the RAN node receives IAB traffic encapsulated over an Ethernet interface and transmits it over the NR interface.

In still another particular embodiment, the RAN node receives IAB traffic from a NR interface and transmits it encapsulated over an Ethernet interface.

In a particular embodiment, the RAN node can switch the IAB traffic received on a NR or an Ethernet interface to either a NR interface or an Ethernet interface.

In a particular embodiment, a method is provided for assigning Ethernet or IAB connections, when multiple alternatives to the next IAB nodes exist, depending on the traffic priority of the destination IAB node.

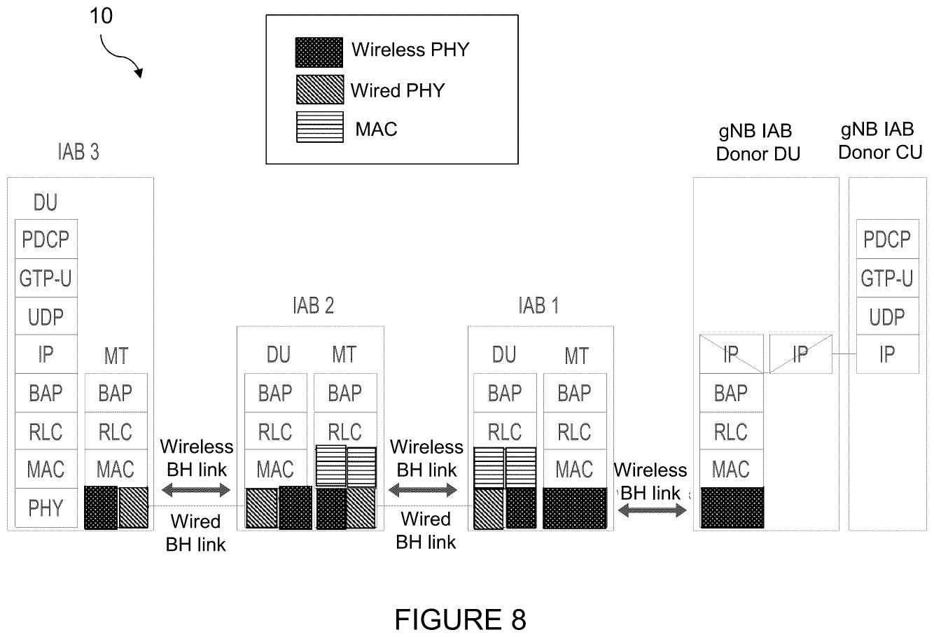

FIG. 8 illustrates an example IAB network 10 with nodes having multiple PHYs at the IAB-DU and/or IAB-MT, according to certain embodiments. In various embodiments, the IAB-MT and/or IAB-DU functions will have a wireless (or radio) PHY (such as, for example, NR) and/or a wired PHY (such as, for example, optical or coaxial cable) and a single MAC entity (NR). For example, in the example embodiment of FIG. 8, both the DU and the MT functions of IAB2 have a wireless PHY and a wired PHY. However, as depicted for IAB3 and IAB1 in FIG. 8, only one function (DU or MT) of the IAB nodes have a wired and wireless PHY. It may be noted that this embodiment relies on the (wireless/NR) MAC layer in the IAB node delivering a transport block for the underlying PHY (wired or wireless).

In the example, the IAB node IAB2 has two protocol stacks for transmission and receiving of IAB data, i.e. one protocol stack for a radio link and one protocol stack for a particular non-radio (e.g. wired) technology. In further examples, the IAB node may comprise one or more further protocol stacks. The radio protocol stack for the radio link and the non-radio protocol stack for the wired technology are at least partially different. For example, the protocol stacks may have at least a physical layer, PHY, which are different. Other layers may be different and present in both, e.g. RLC. Other layers may be common and the same for both protocol stacks.

In the illustrated embodiment depicted in FIG. 8, there is one MAC entity for each PHY. Stated differently, there is one MAC entity for wired PHY and another MAC entity for wireless PHY. In this case, if both the wired and wireless backhaul link are directed to a same child IAB node (for example, IAB2 in FIG. 8), then it can be viewed as a Carrier Aggregation/Link Aggregation Group (CA/LAG) in the downlink and/or uplink. This type of CA/LAG can be categorized as intra-band CA/LAG, where the wired MAC will serve as a SCell or PCell. In addition, the wired MAC can serve as a single cell or multiple cells depending on the deployment scenarios.

Activation/deactivation of component carriers (or cells) can be done via MAC CEs. However, it is the RRC sublayer (of the IAB-Donor CU in this case) that provides cell management functions, such as addition/modification/release of SCell(s). Such changes can be independent of the used PHY.

Depending on the deployment scenarios, the IAB-Donor CU RRC can configure different number of cells for the downlink and uplink. Another possible configuration scenario could be that the wired PHY only provide SCell(s) in the downlink and not in the uplink, but the wireless backhaul link is used for transferring the traffic.

In the illustrated scenario, the IAB-Donor CU is oblivious to the wired PHY and, thus, no changes to the RAN2/RAN3 related specifications are needed to enable IAB network node with wired PHY.

For the BAP layer, the wired MAC could appear like a wireless MAC. Thus, BAP transport blocks can be carried/forward via the wired MAC towards a child IAB node.

In some examples, the IAB node is configured to use a radio or non-radio link, and hence a particular protocol stack, based on received signaling. In some examples, the BAP layer is used to signal to the IAB node which link to use. In some examples, the signaling originates from a donor IAB node or another node, e.g. another IAB node or a control node. In some aspects, the BAP layer determines which of the radio or non-radio link to use. As such, it is configuration of the BAP layer determines which of the radio or non-radio link to use. The layers of the protocol stack below the BAP layer are then specific to the radio link or non-radio link.

For example, when it comes to path decisions, according to certain embodiments, the BAP of the IAB node could route high priority data or data with high QoS requirements via the wired MAC and best effort traffic via the wireless MAC. Additionally, in particular embodiments, the dedicated signaling data can be transferred through the wired link, e.g. wired MAC. In other embodiments, however, all the data traffic along (including the dedicated signaling data) can be transferred via the wired MAC, while the wireless MAC is only used for broadcast signaling or serving access UEs, separating backhaul in access data over different media. Alternatively, in some examples, the IAB node can autonomously determine whether to use the radio or non-radio link for transmission.

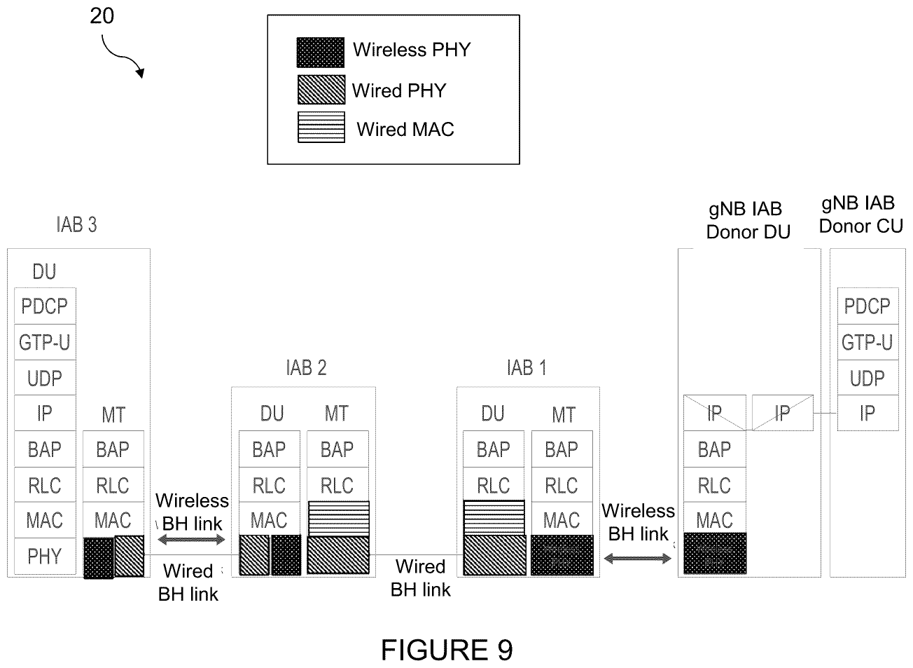

FIG. 9 illustrates an example IAB network 20 with nodes IAB1 and IAB2 having a wired MAC in DU and MT, respectively, according to certain embodiments. Thus, the whole NR MAC (including NR PHY) is substituted by a wired MAC (e.g., Ethernet and including the wired PHY). In the illustrated embodiment, the wired MAC will simply adapt the received RLC PDU into an appropriate signaling format (e.g., analog or/and digital format) without performing any functionalities for the radio (e.g. NR) physical layer (PHY) and will then transport them towards the child IAB node. According to certain embodiments, the wired MAC layer is transparent to the NR/wireless RLC layer and IAB higher layers.

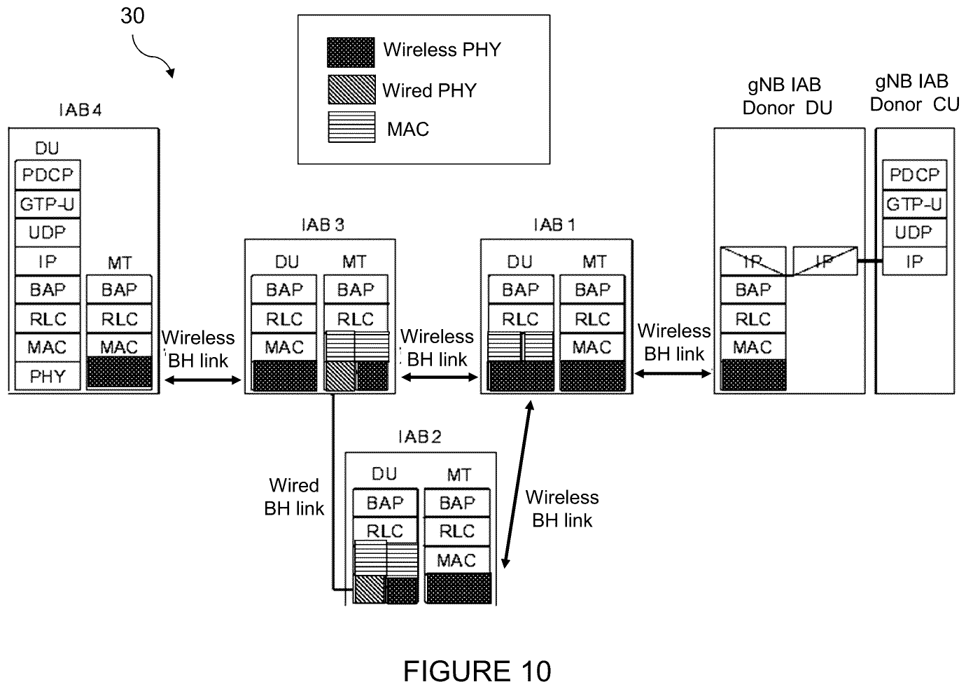

In another particular embodiment, the wired MAC is used to enable multi-connectivity and topology redundancy for improved robustness and load balancing purposes. For instance, FIG. 10 illustrates an example of an IAB network 30 using wired PHY for multi-connectivity purposes, according to certain embodiments. As illustrated, the IAB3 node employs the wired PHY to establish an additional wired backhaul link with IAB2 apart from the wireless backhaul link with IAB1.

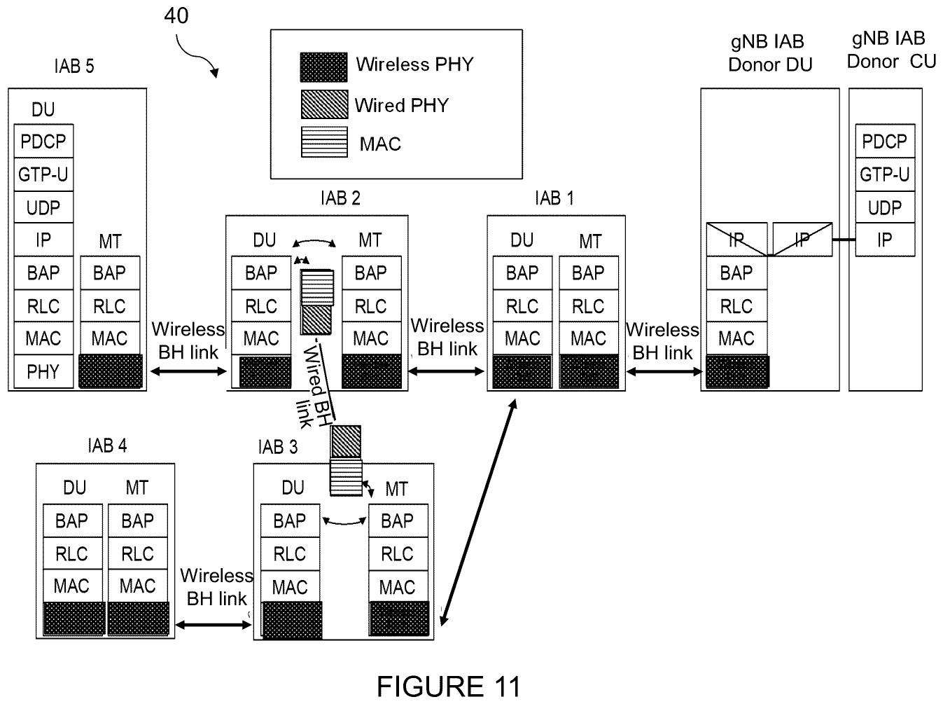

In another particular embodiment, a new wired MAC cross-connects a complete MT and/or DU function associated to different IAB-nodes. For example, FIG. 11 illustrates an example IAB network 40 with direct wired connection between MT and DU functions belonging to different IAB nodes, according to certain embodiments. Here, instead of via the MT of IAB-node 2, traffic is forwarded to the DU of IAB-node 2 via the MT of IAB-node 3 (e.g. in case the wireless link between IAB-node 1 and 2 is (permanently) not acceptable for some reason), via a wired PHY directly connecting the MT of IAB-node 3 and the DU of IAB-node 2. This is preferably done on IAB BAP layer-level when interfaces can be implemented compatible to terminating IP (Internet Protocol). This can be considered as cross-connecting IAB functions between different IAB nodes.

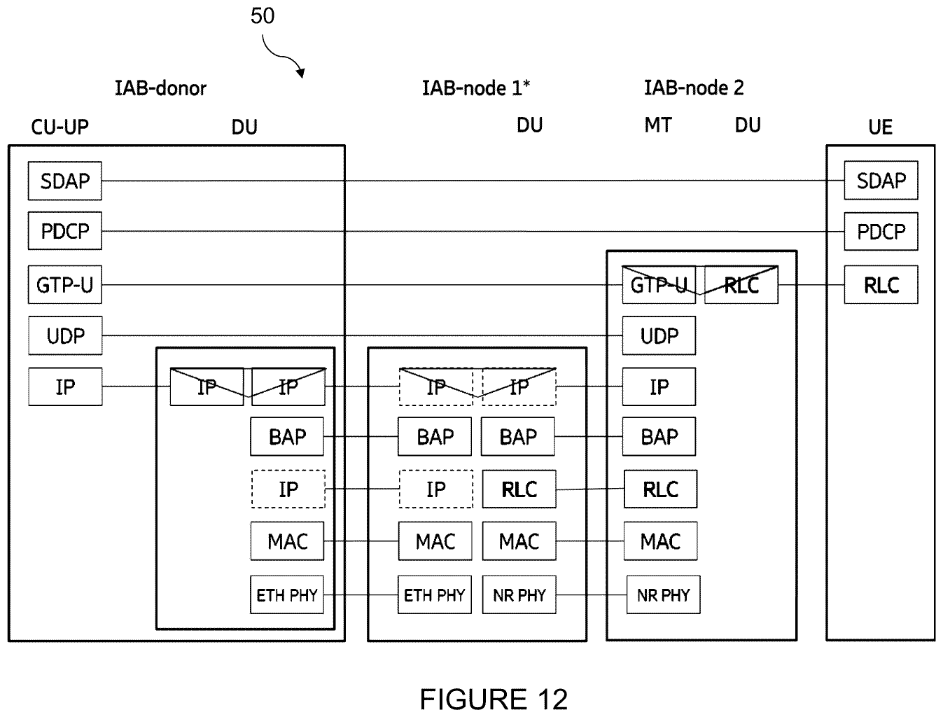

FIG. 12 illustrates an example of an IAB network 50 with the IAB-1 and IAB-donor having ethernet PHY for transporting F1 user plane traffic, according to certain embodiments. Thus, FIG. 12 shows F1 data plane flow using encapsulated IAB as described herein. As illustrated, the IAB-donor DU and IAB-1 MT have an IP layer instead of an RLC layer. It may be noted that the data plane flow is completely transparent to the IAB child node in this example.

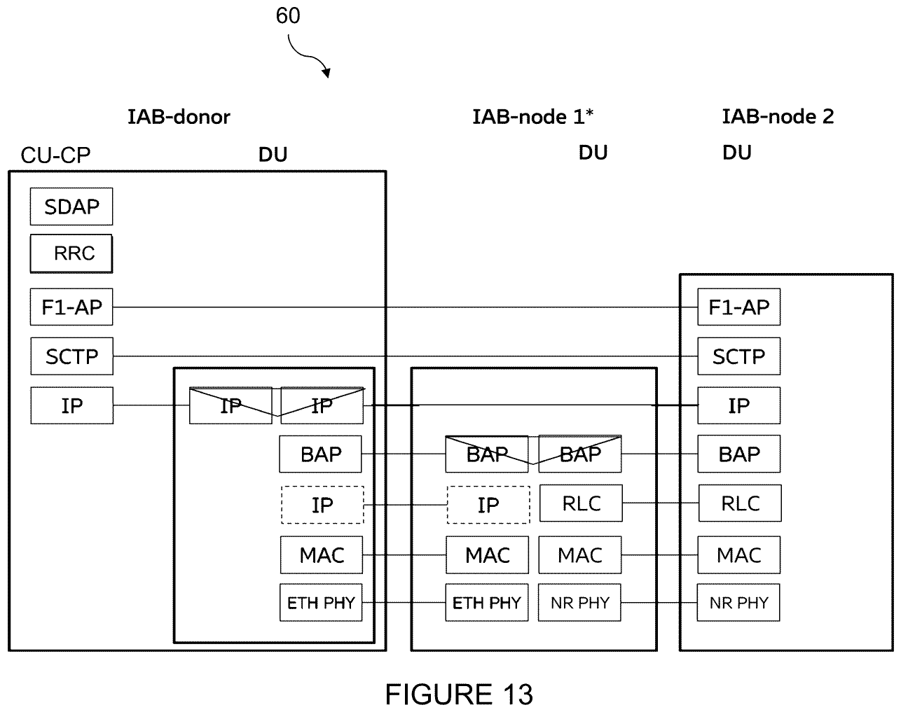

FIG. 13 illustrates an example of an IAB network 60 with the IAB-1 MT and IAB-donor DU having no RLC layer and where the IP layer is optional in IAB-1 for transporting F1 control plane traffic, according to certain embodiments. Thus, FIG. 13 shows E2E control plane for the UE connected using encapsulated IAB as described herein. It may be noted that the data plane flow is completely transparent to the UE in this example.

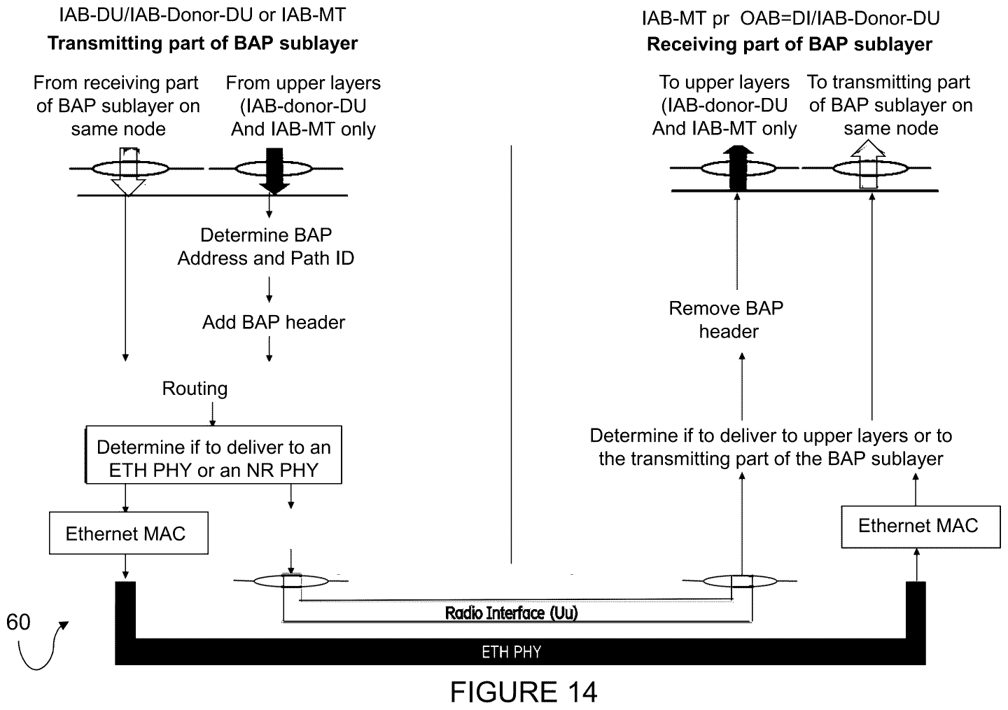

As illustrated in FIGS. 12 and 13, the IAB data is encapsulated over a traditional IP/MAC Ethernet stack for switching over a packet switched fronthaul network. FIG. 14 illustrates an example flowchart 60 for performing encapsulation and using dedicated bits to discriminate BAP packets over Radio from BAP packets over Ethernet, according to certain embodiments. In the illustrated example, the IAB-DU/IAB-Donor-DU or IAB-MT is the transmitting part of the BAP sublayer, and the IAB-MT or IAB-DU/IAB-Donor-DU is the receiving part of the BAP sublayer.

As illustrated, according to certain embodiments, the transmitting part determines whether to deliver to an ETH PHY or a NR PHY. If the transmitting part determines to deliver over the ETH PHY, the packets are routed to the ETH PHY via the Ethernet MAC. Similarly, the receiving part receives the packets via its Ethernet MAC.

Alternatively, if the transmitting part determines to deliver the packets to the NR PHY, then the transmitting part performs a mapping to BH RLC channel and transmits the packets over the Radio Interface (Uu).

The present disclosure provides for transport of IAB data without using a radio technology (e.g. NR) for one or more layers, e.g. the Physical layer, layer 1 or layer 2. As such, transport over a non-radio link is improved. The present disclosure differs from merely using a radio PHY to generate a baseband signal, which is then used to transmit a radio baseband signal over non-radio link. Instead, the use of one or more layers in the protocol stack which are specific to the non-radio link used allows for efficient transmission of the IAB data. Alternatively, the disclosure may be considered as not using, or omitting, one or more radio layers, e.g. PHY, intended for radio transmission from the protocol stack.

Any references to ethernet, ETH PHY, wired link, non-IAB transport link may refer to any non-radio transport of IAB data. The non-radio transport includes a wired link such as optical fiber or electrical cable, or a non-wired link such as a microwave link.

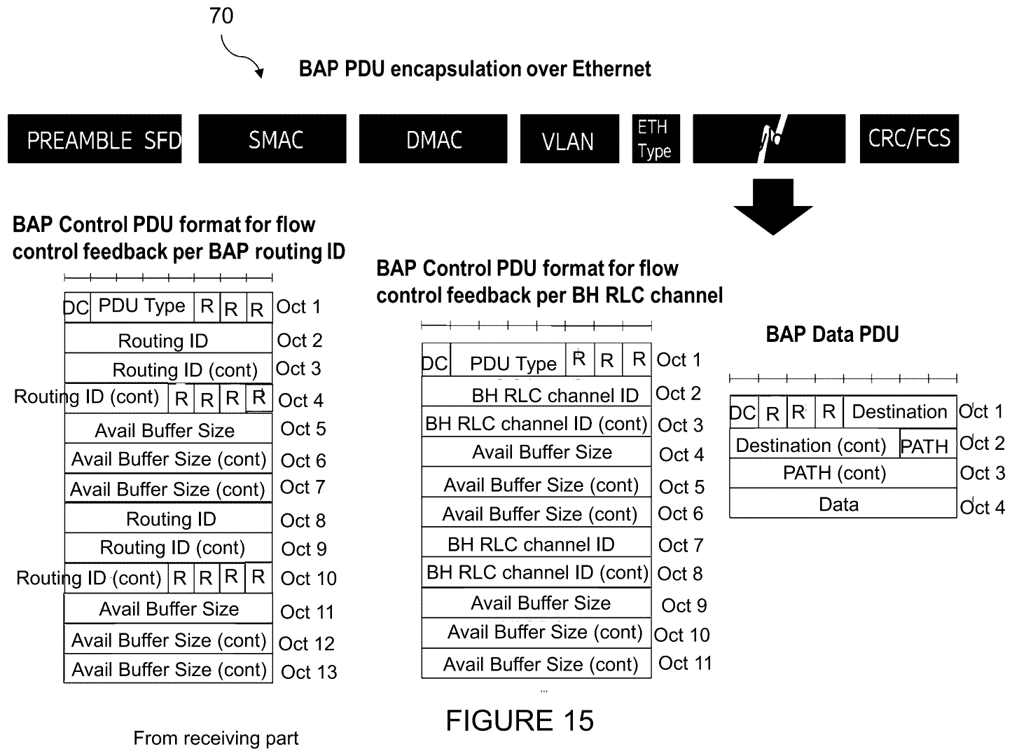

FIG. 15 illustrates BAP PDU encapsulation 70 over Ethernet, according to certain embodiments. As illustrated, FIG. 15 shows that the embodiments described herein is fully compatible with Ethernet frames since BAP packets are encapsulated within the Ethernet payload. FIG. 15 also demonstrates that there may be 3 types of BAP packets.

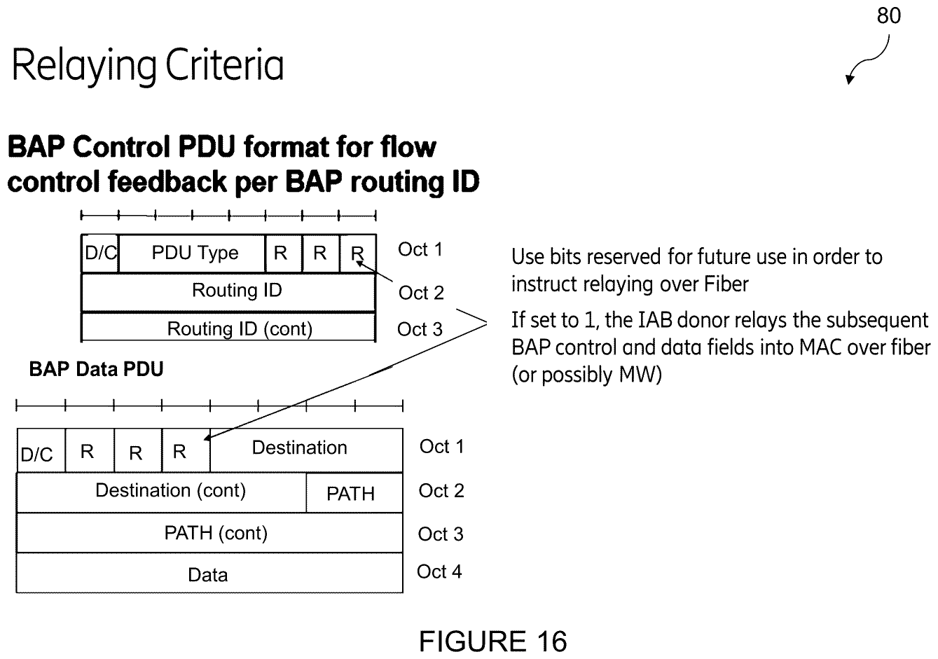

FIG. 16 illustrates a BAP Control PDU format 80 for flow control feedback per BAP routing ID, according to certain embodiments. Specifically, as shown in FIG. 16, an existing bit, which is reserved but previously unused, is now used to indicate that the transmitting part is transmitting over ethernet non-radio such as, for example, microwave.

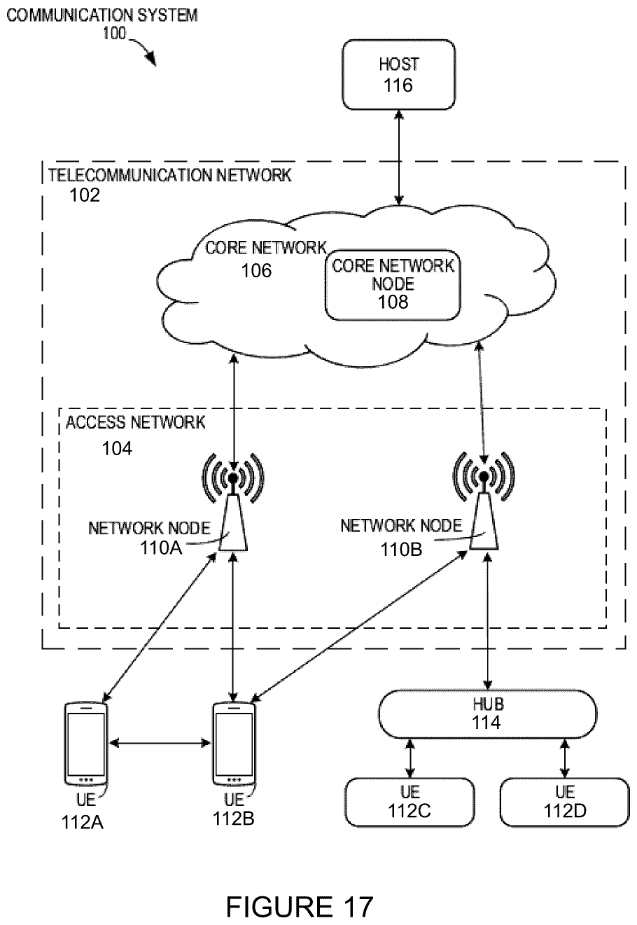

FIG. 17 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub-that is, a hub whose primary function is to route communications to/from the UEs from/to the network node 110b. In other embodiments, the hub 114 may be a non-dedicated hub-that is, a device which is capable of operating to route communications between the UEs and network node 110b, but which is additionally capable of operating as a communication start and/or end point for certain data channels.

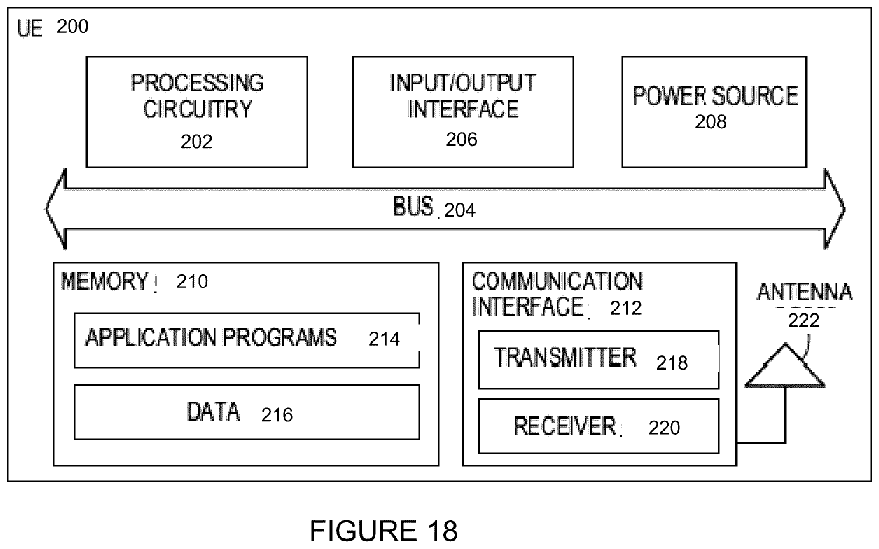

FIG. 18 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software: or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

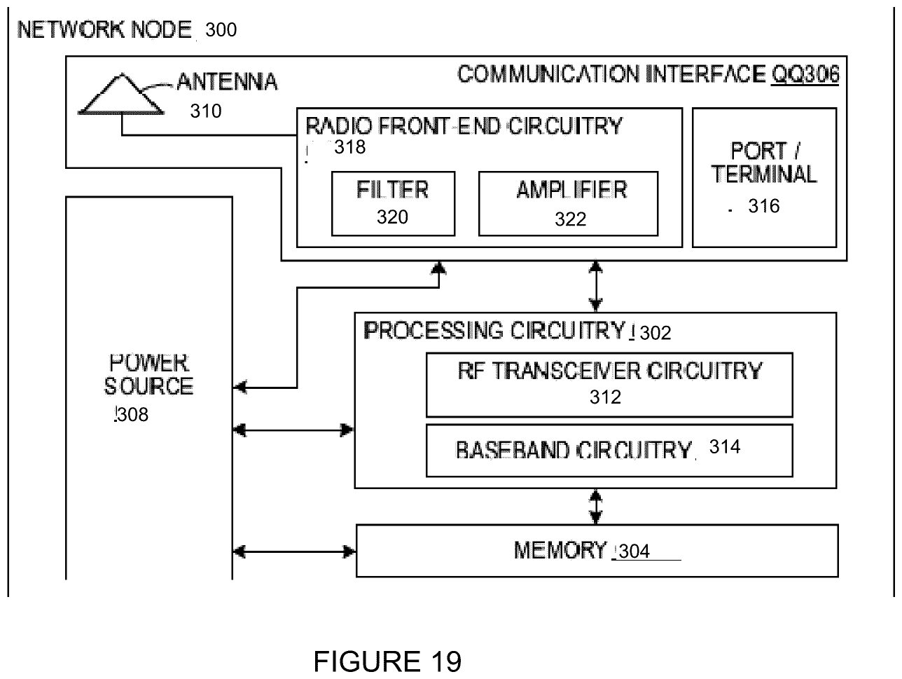

FIG. 19 shows a network node 300 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 19 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

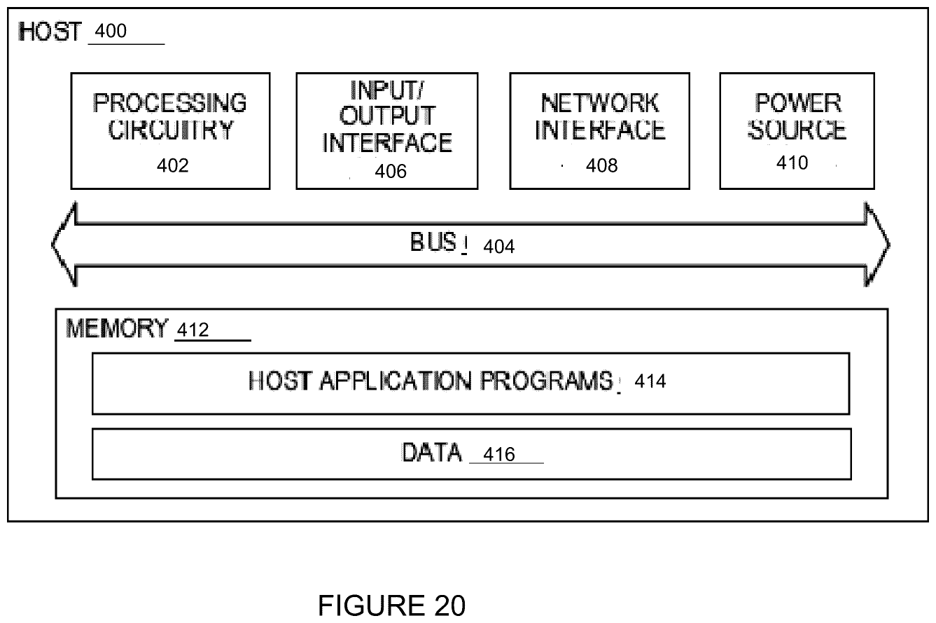

FIG. 20 is a block diagram of a host 400, which may be an embodiment of the host 116 of FIG. 17, in accordance with various aspects described herein.

As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

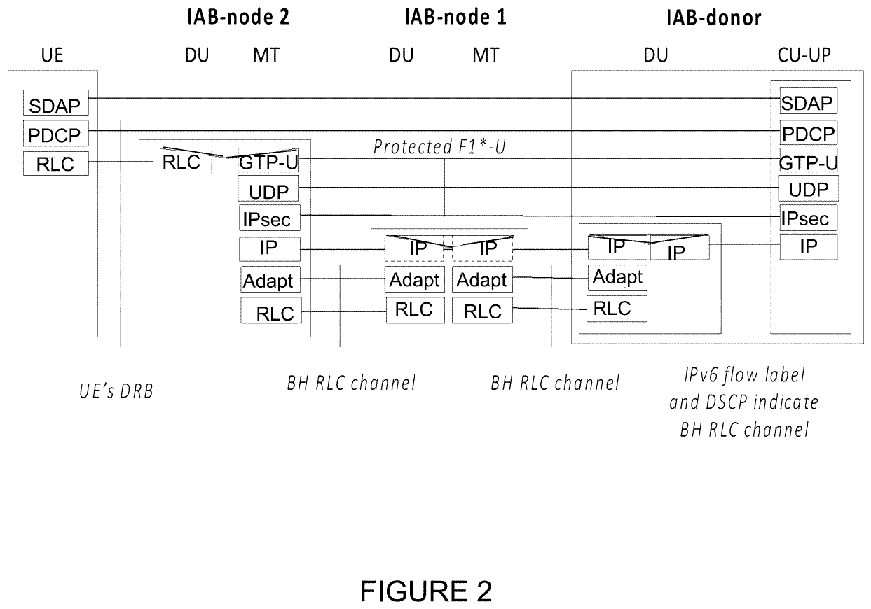

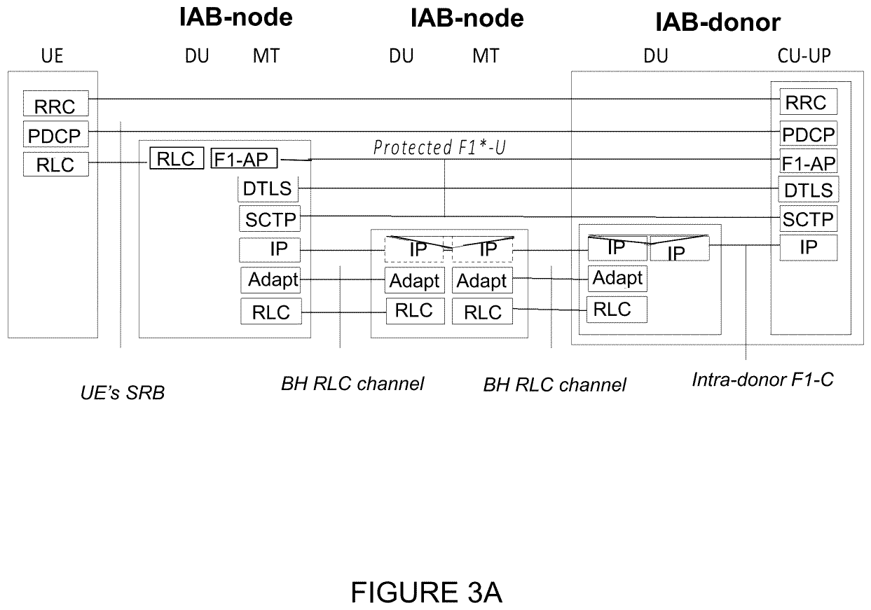

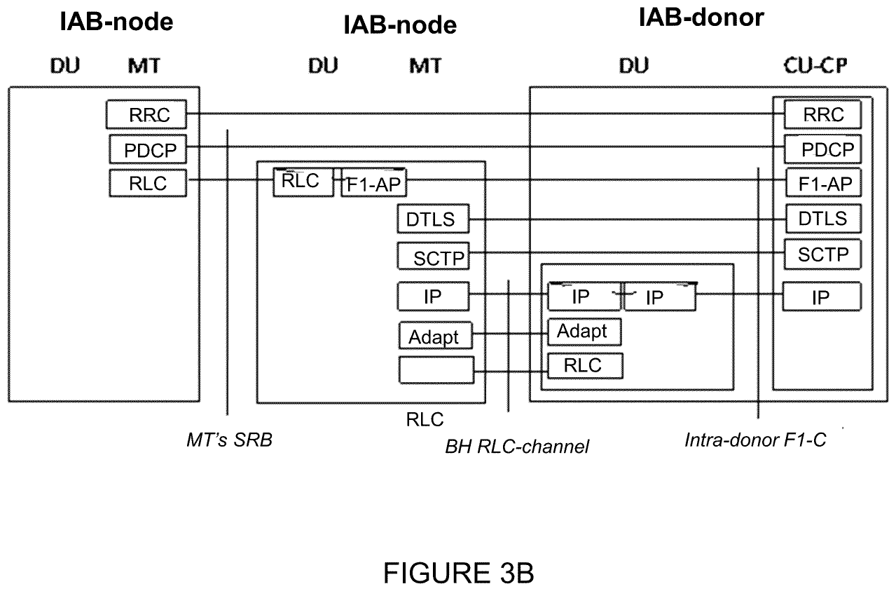

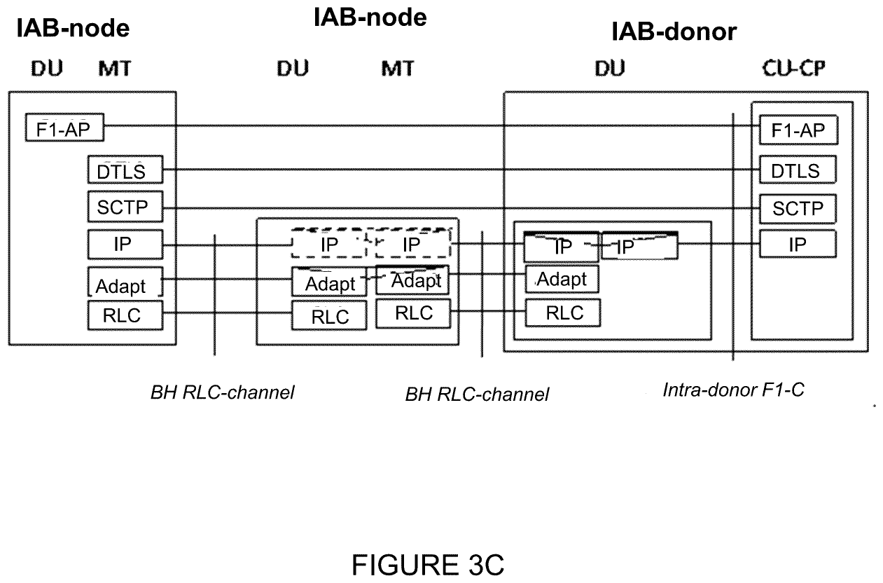

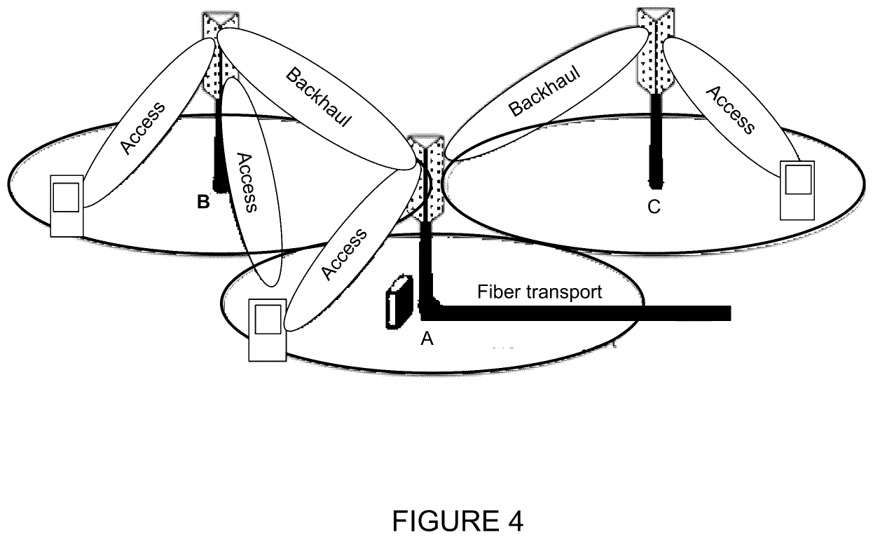

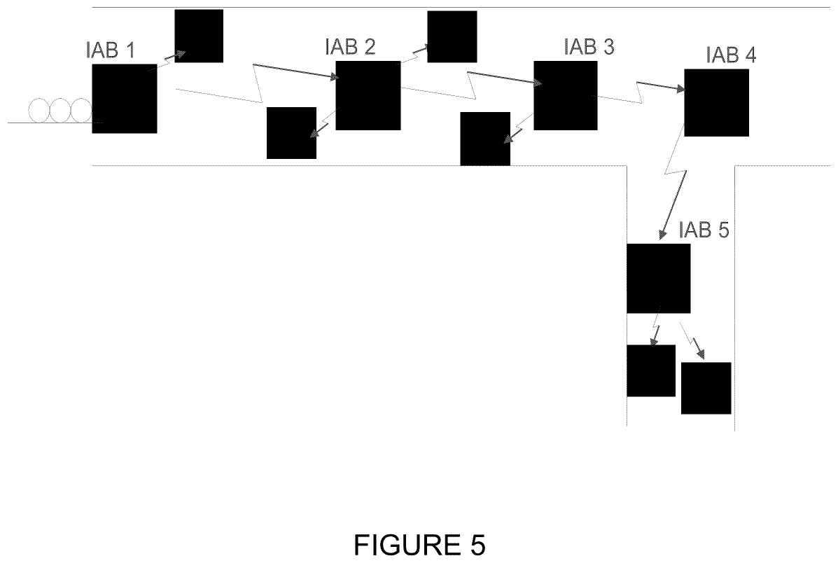

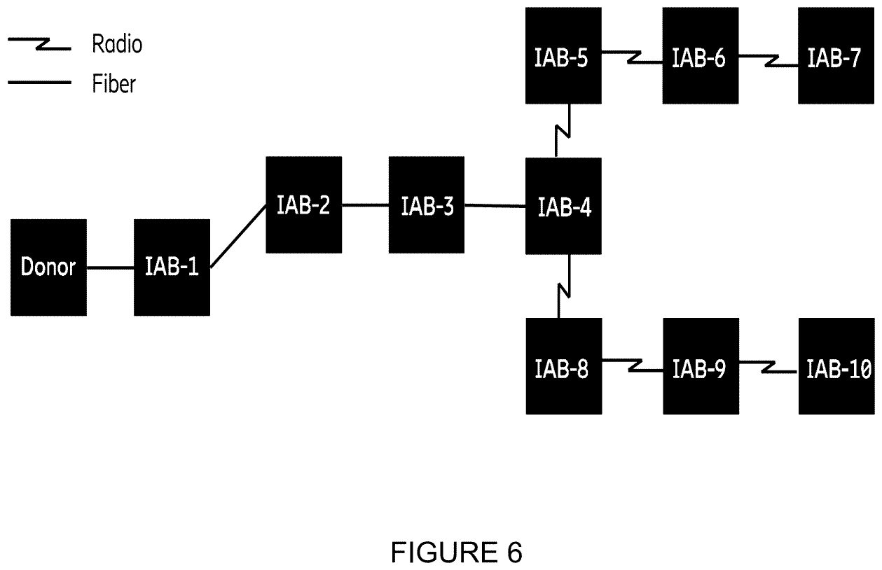

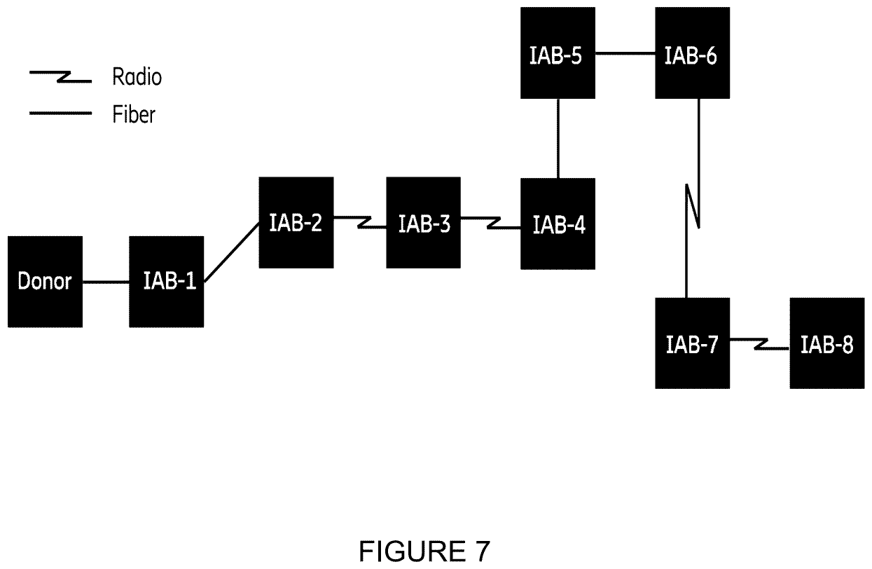

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol. Real-Time Messaging Protocol (RTMP), Real-Time Streaming Protocol (RTSP), Dynamic Adaptive Streaming over HTTP (MPEG-DASH), etc.

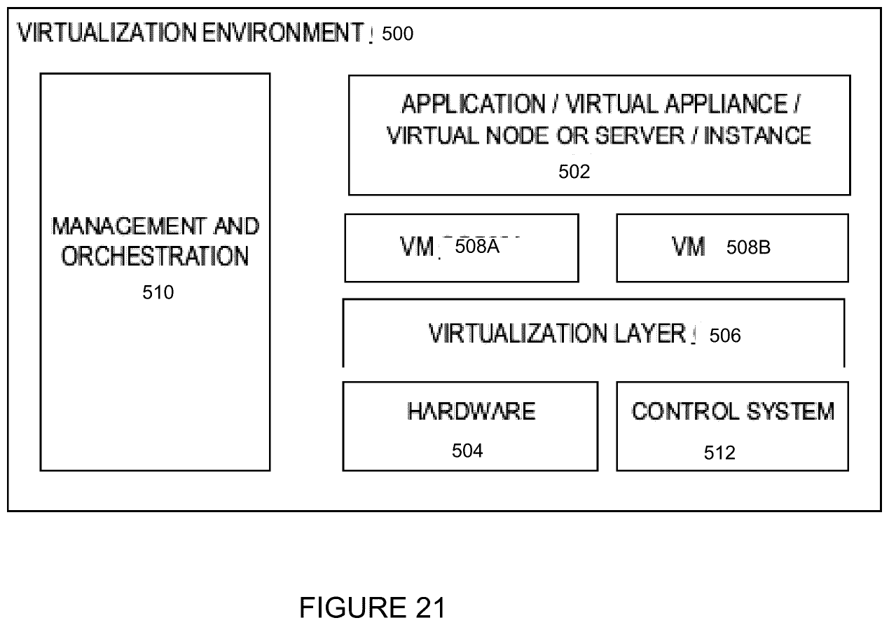

FIG. 21 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

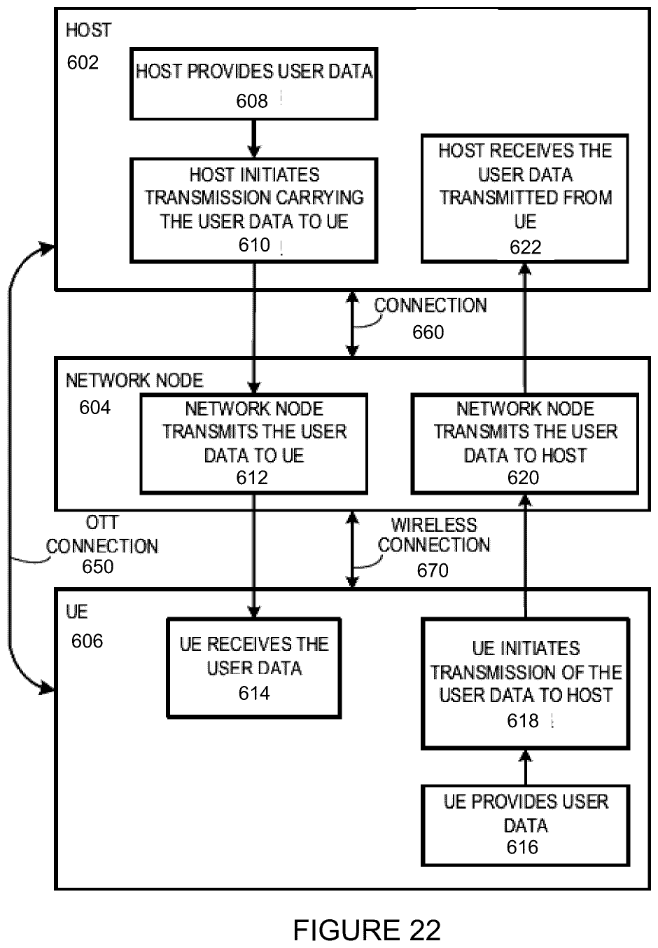

FIG. 22 shows a communication diagram of a host 602 communicating via a network node 604 with a UE 606 over a partially wireless connection in accordance with some embodiments.

Example implementations, in accordance with various embodiments, of the UE (such as a UE 112a of FIG. 17 and/or UE 200 of FIG. 18), network node (such as network node 110a of FIG. 17 and/or network node 300 of FIG. 19), and host (such as host 116 of FIG. 17 and/or host 400 of FIG. 20) discussed in the preceding paragraphs will now be described with reference to FIG. 22.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 17) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput. propagation times, latency and the like, by the host 602. The measurements may be implemented in that software causes messages to be transmitted, in particular empty or ‘dummy’ messages, using the OTT connection 650 while monitoring propagation times, errors, etc.

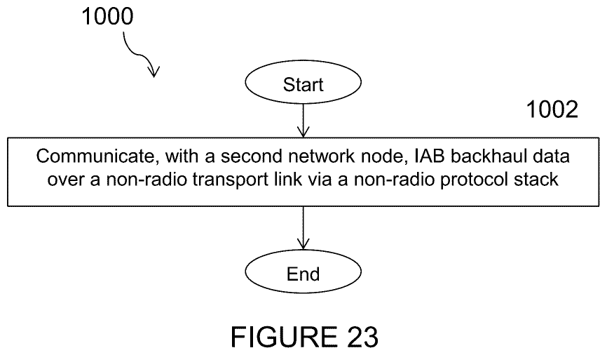

FIG. 23 illustrates a method 1000 by a first network node 110 implementing IAB protocols, according to certain embodiments. At step 1002, the first network node 110 communicates, with a second network node 110, IAB data over a non-radio transport network via a non-radio transport protocol stack. In a particular embodiment, the non-radio transport network may include a point-to-point link.

In a particular embodiment, the first network node 110 is adapted to communicate with the second network node via the non-radio transport network and a radio transport network. Thus, the first network node 110 is configured to use either or both of the non-radio transport network and the radio transport network.

In a particular embodiment, the first network node 110 determines whether to transmit IAB data over the non-radio transport network or the radio transport network.

In a particular embodiment, the first network node 110 receives, from an IAB donor node, a message indicating to change a link for communicating the IAB data. For example, the message may include a new routing table created by the donor node. Based on the message, the first network node 110 then changes the link for communicating the IAB data from a link associated with the radio transport protocol stack to a link associated with the non-radio transport protocol stack. Alternatively, the first network node 110 may change the link for communicating the IAB data from a link associated with the non-radio transport protocol stack to a link associated with the radio transport protocol stack.

In a further particular embodiment, changing the link from the link associated with the radio transport protocol stack to the link associated with the non-radio transport protocol stack is controlled by a BAP layer of the first network node.

In a further particular embodiment, the IAB data includes at least one BAP data unit, and the first network node 110 determines to perform the change based on a field of the at least one BAP data unit.

In a particular embodiment, the first network node 110 is a IAB donor node.

In a particular embodiment, the first network node 110 transmits, to the second network node, a message indicating to change to the non-radio transport protocol stack.

In a particular embodiment, the non-radio transport protocol stack includes a wired PHY and a wired MAC carrying RLC and BAP.

In a particular embodiment, the IAB data comprises IAB protocol data units. For example, the IAB protocol data units may be BAP protocol data units. The first network node 110 encapsulates the IAB protocol data units over the non-radio transport protocol stack.

In a particular embodiment, the non-radio transport network comprises a packet switched transport network or a circuit switched transport network. As used herein a packet switched transport network includes Ethernet (wired and wireless), and a circuit switched transport network is TDM (wired and wireless) or WDM (wired only). Examples of wireless circuit switched networks include a point-to-point dedicated microwave link or a dedicated carrier, band, sub-band, or dedicated spectrum access in any wireless transmission technology between the relevant nodes. Examples of a wireline circuit switched network may include SONET/SDH and OTN.

In a particular embodiment, communicating the IAB data with the second network node comprises receiving the IAB data from the second network node over the non-radio transport network via the non-radio transport protocol stack. The first network node 110 transmits the IAB data to a third network node over another non-radio transport network or a radio transport network.

In a particular embodiment, communicating the IAB data with the second network node comprises transmitting the IAB data to the second network node over the non-radio transport network via the non-radio transport protocol stack.

In a particular embodiment, prior to transmitting the IAB data, the first network node 110 receives the IAB data from a third network node over another non-radio transport network via another non-radio transport protocol stack. Alternatively, the first network node 110 receives the IAB data from the third network node over a radio transport network via a radio transport protocol stack.

In a particular embodiment, the non-radio transport link comprises at least one of a fiber link, microwave, free space optics, and visual light communication.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method by a first network node implementing Integrated Access and Backhaul, IAB, protocols, the method comprising:
communicating, with a second network node, Integrated Access Backhaul, IAB, data over a non-radio transport network via a non-radio transport protocol stack.

2. The method of claim 1, wherein the first network node is adapted to communicate with the second network node via the non-radio transport network and a radio transport network.

3. The method of claim 2, further comprising:
determining whether to transmit IAB data over the non-radio transport network or the radio transport network.

4. The method of claim 2, further comprising:
receiving, from an IAB donor node, a message indicating to change a link for communicating the IAB data; and
based on the message, changing the link for communicating the IAB data from a link associated with the radio transport protocol stack to a link associated with the non-radio transport protocol stack or from a link associated with the non-radio transport protocol stack to a link associated with the radio transport protocol stack.

5. The method of claim 4, wherein changing the link from the link associated with the radio transport protocol stack to the link associated with the non-radio transport protocol stack is controlled by a Backhaul Adaptation Protocol, BAP, layer of the first network node optionally wherein the IAB data comprises at least one BAP data unit, and the method further comprises determining to perform the change based on a field of the at least one BAP data unit.

6.-8. (canceled)

9. The method of claim 1, wherein the non-radio transport protocol stack includes a wired physical layer, PHY, and a wired Medium Access Control, MAC carrying radio link control, RLC, and Backhaul Adaptation Protocol, BAP.

10. The method of claim 1, wherein the IAB data comprises IAB protocol data units, and wherein the method further comprises encapsulating the IAB protocol data units over the non-radio transport protocol stack.

11. (canceled)

12. The method of claim 1, wherein communicating the IAB data with the second network node comprises receiving the IAB data from the second network node over the non-radio transport network via the non-radio transport protocol stack, and wherein the method further comprises:
transmitting the IAB data to a third network node over another non-radio transport network or a radio transport network.

13. The method of claim 1, wherein communicating the IAB data with the second network node comprises transmitting the IAB data to the second network node over the non-radio transport network via the non-radio transport protocol stack.

14. The method of claim 13, wherein prior to transmitting the IAB data, the method further comprises:
receiving the IAB data from a third network node over another non-radio transport network via another non-radio transport protocol stack, or
receiving the IAB data from the third network node over a radio transport network via a radio transport protocol stack.

15. (canceled)

16. A first network node implementing Integrated Access and Backhaul, IAB, protocols, the first network node being adapted to:
communicate, with a second network node, Integrated Access Backhaul, IAB, data over a non-radio transport network via a non-radio transport protocol stack.

17. The first network node of claim 16, being further adapted to communicate with the second network node via the non-radio transport network and a radio transport network.

18. The first network node of claim 17, being further adapted to determine whether to transmit IAB data over the non-radio transport network or the radio transport network.

19. The first network node of claim 16, further adapted to:
receive, from an IAB donor node, a message indicating to change a link for communicating the IAB data; and
based on the message, change the link for communicating the IAB data from a link associated with the radio transport protocol stack to a link associated with the non-radio transport protocol stack or from a link associated with the non-radio transport protocol stack to a link associated with the radio transport protocol stack.

20. The first network node of claim 19, further comprising a Backhaul Adaptation Protocol, BAP, layer configured to control changing the link from the link associated with the radio transport protocol stack to the link associated with the non-radio transport protocol stack optionally wherein the IAB data comprises at least one BAP data unit, and the first network node is further adapted to determine to perform the change based on a field of the at least one BAP data unit.

21.-23. (canceled)

24. The first network node of claim 16, wherein the non-radio transport protocol stack includes a wired physical layer, PHY, and a wired Medium Access Control, MAC carrying radio link control, RLC, and Backhaul Adaptation Protocol, BAP.

25. The first network node of claim 16, wherein the IAB data comprises IAB protocol data units, and wherein the first network node is further adapted to encapsulate the IAB protocol data units over the non-radio transport protocol stack.

26. (canceled)

27. The first network node of claim 16, wherein, when communicating the IAB data with the second network node, the first network node is adapted to receive the IAB data from the second network node over the non-radio transport network via the non-radio transport protocol stack, and wherein the first network node is further adapted to:
transmit the IAB data to a third network node over another non-radio transport network or a radio transport network.

28. The first network node of claim 16, wherein, when communicating the IAB data with the second network node, the first network node is adapted to transmit the IAB data to the second network node over the non-radio transport network via the non-radio transport protocol stack.

29. The first network node of claim 28, wherein prior to transmitting the IAB data, the first network node is adapted to:
receive the IAB data from a third network node over another non-radio transport network via another non-radio transport protocol stack, or
receive the IAB data from the third network node over a radio transport network via a radio transport protocol stack.

30. (canceled)
